(19) United States
(12) Patent Application Publication
(10) Pub. No.: US 2021/0162903 A1
(43) Pub. Date: Jun. 3, 2021

(54) RATCHETING HEADREST ASSEMBLY

(71) Applicant: WINDSOR MACHINE AND STAMPING (2009) LTD., Windsor (CA)

(72) Inventor: Mark Little, Windsor (CA)

(21) Appl. No.: 17/106,397

(22) Filed: Nov. 30, 2020

Related U.S. Application Data
(60) Provisional application No. 62/942,433, filed on Dec. 2, 2019.

(51) Int. Cl. B60N 2/865; B60N 2/847; B60N 2/853

(52) U.S. Cl. CPC B60N 2/865; B60N 2/853; B60N 2/847

(57) ABSTRACT

A headrest assembly for use in an automobile that is pivotal in the fore-aft direction. The headrest assembly includes a housing formed of a front shell and a rear shell. An armature operatively couples the housing to a seatback of an automobile seat. A ratchet mechanism couples the housing to the armature and effectuates the pivotal movement. The ratchet mechanism includes a fixed ratchet member statically connected to the armature and that defines a plurality of fixed ratchet teeth. The ratchet mechanism also includes a moveable ratchet member pivotally connected to the housing and that defines a plurality of moveable ratchet teeth. The moveable ratchet member is biased in an engaged position wherein the fixed ratchet teeth and the moveable ratchet teeth are interlocked and hold the housing a varying pivot angles in the fore-aft direction with respect to the seatback.

### CROSS-REFERENCE TO RELATED APPLICATION

This United States Utility Application claims the benefit of and priority to U.S. Provisional Patent Application No. 62/942,433, filed Dec. 2, 2019, and titled “RATCHETING HEADREST ASSEMBLY,” the entire disclosure of which is hereby incorporated by reference.

### BACKGROUND OF THE INVENTION

### 1. Field of the Invention

The present invention relates to vehicle headrests and, more particularly, to a headrest assembly that is pivotable in a fore-aft direction.

### 2. Related Art

This section provides background information related to the present disclosure which is not necessarily prior art.

Technological improvements of automobiles have generally been focused on categorical enhancements to efficiency, safety, and comfort. Oftentimes, an improvement in one category detracts from one of the other categories. For example, there has been a consistent struggle throughout the historical development of automobiles to find a balance between strength and weight. While incorporating stronger components may ultimately lead to a safer driving experience, stronger materials are typically heavier than other materials and thus detract from operational efficiency, e.g., fuel economy. Similarly, a focus primarily on efficiency can lead to components that are vulnerable to impact events and normal wear and tear.

One example component of an automobile that has historically been developed with an emphasis on balancing strength and comfort is a headrest. Most automobiles include headrests atop an occupant's seat and in a position adjacent the occupant's head. Because headrests are specifically designed to interface with an occupant's head, they must be comfortable both tactilely and positionally. In addition to comfort, headrests must be able to withstand certain amounts of impact to prevent whiplash to the occupant during a rear end collision, and, to a certain extent, block foreign objects from moving forward in the event of a crash or sudden braking situation. Developments in comfort functionality and, more particularly, positional adjustment for both safety and comfort have resulted in headrests having relatively complicated adjustment mechanisms that allow several users of varying sizes and preferences to adjust the headrest to an ideal position.

Accordingly, there is a continued desire to develop headrests that provide positional comfort, that are strong, and that do not detract from operational efficiency of an automobile.

### SUMMARY OF THE INVENTION

This section provides a general summary of the disclosure and is not to be interpreted as a complete and comprehensive listing of all of the objects, aspects, features and advantages associated with the present disclosure.

In accordance with one aspect, the present invention provides a headrest assembly for use in an automobile. The headrest assembly comprises a housing and a ratchet mechanism coupling the housing to a provided armature. The ratchet mechanism comprises a fixed ratchet member for static connection to the provided armature and defining a plurality of fixed ratchet teeth. A moveable ratchet member is pivotally connected to the housing and defines a plurality of moveable ratchet teeth. The moveable ratchet member is moveable between an engaged position and a released position. The engaged position is at least partially defined by the fixed ratchet teeth and the moveable ratchet teeth interlocked at varying pivot angles in the fore-aft direction with respect to the provided armature. The unengaged position is at least partially defined by the fixed ratchet teeth and the moveable ratchet teeth being spaced from one another.

In accordance with another aspect, the present invention provides a headrest assembly for use in an automobile. The headrest assembly comprises a housing, an armature for operatively coupling the housing to a provided seatback of an automobile seat, and a ratchet mechanism coupling the housing to the armature. The ratchet mechanism comprises a fixed ratchet member for static connection to the provided armature and defining a plurality of fixed ratchet teeth. A moveable ratchet member is connected to the housing and defines a plurality of moveable ratchet teeth. The moveable ratchet member is moveable between an engaged position and a released position. The engaged position is at least partially defined by the fixed ratchet teeth and the moveable ratchet teeth interlocked at varying pivot angles in the fore-aft direction with respect to the provided armature. The unengaged position is at least partially defined by the fixed ratchet teeth and the moveable ratchet teeth being spaced from one another.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of a headrest assembly for an automobile that is pivotable in a fore-aft direction;

FIG. 2A is a side view of the headrest assembly in a first position;

FIG. 2B is a side view of the headrest assembly in a second position;

FIG. 3 is a disassembled front perspective view of the headrest assembly;

FIG. 4 is a rear perspective view of a front shell of the headrest assembly;

FIG. 5A is a side cross-sectional view of a ratchet mechanism in an engaged position for preventing the headrest assembly from pivoting in the aft direction but allowing the headrest assembly to pivot in the fore direction to a preferred position;

FIG. 5B is a side cross-sectional view of the ratchet mechanism in a released position for allowing the headrest assembly to be pivoted back in the aft direction to reset the headrest assembly position to a starting location;

FIG. 6 is a rear perspective view of a headrest assembly in accordance with another aspect of the disclosure;

FIG. 7A is a disassembled rear perspective view of the headrest assembly of FIG. 6; and

FIG. 7B is an enlarged partial view of an interior side of a rear shell of FIG. 6.

### DESCRIPTION OF THE ENABLING EMBODIMENTS

Example embodiments will now be described more fully with reference to the accompanying drawings. In general, the subject embodiments are directed to a headrest assembly for an automobile that is pivotable in a fore-aft direction. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that some specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the headrest assembly is intended for providing an enhanced travel experience to occupants of an automobile by allowing the headrest assembly to be pivotable in a fore-aft direction.

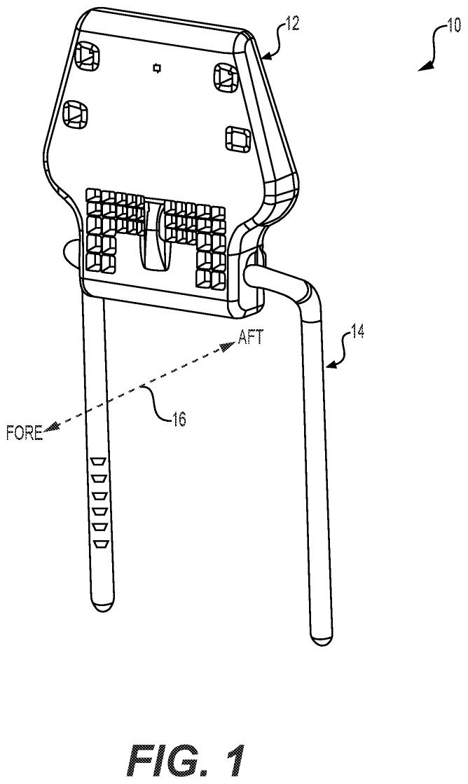

Referring initially to FIG. 1, a headrest assembly is depicted. The headrest assembly is generally referred to with numeral 10. The headrest assembly 10 includes a housing 12 that at least partially encloses several components associated with stabilization and/or adjustment of the headrest assembly 10. A cushion and a cover (not shown) may be provided over the housing 12 for aesthetic purposes and occupant comfort, i.e., tactile comfort. A base portion 14 (which may also be referred to as “armature”) is mountable to an automobile seat and, more specifically, to a top surface of a seatback of the automobile seat (not shown).

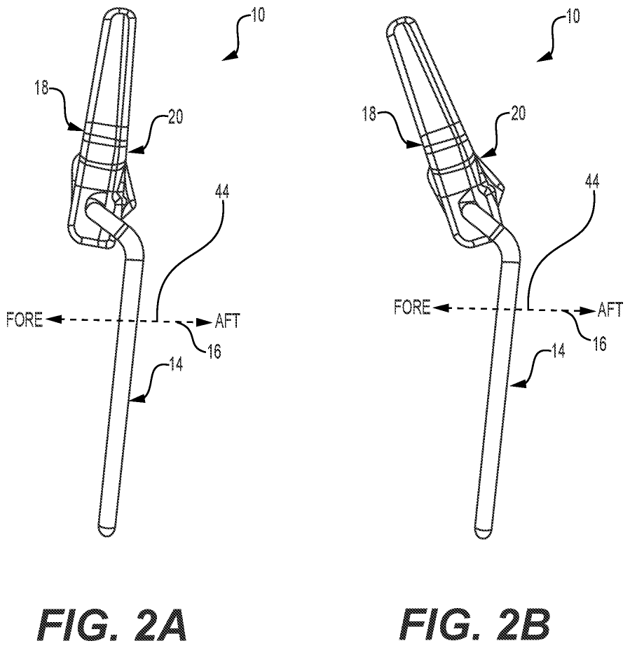

As best illustrated in FIGS. 2A and 2B, the embodiments described herein allow pivoting of the headrest assembly 10 in a fore-aft direction 16 with respect to the top surface of the seatback. The pivoting and pivotable movement described herein may also be referred to as rotating or tilting of the headrest. The extent of the movement of the headrest 10 may vary depends upon the particular application of use. In some arrangements, the headrest 10 is pivotal in the fore-aft direction up to about 180° to bring the headrest 10 into substantially flush contact with the seatback in the fore and aft directions, but in other arrangements the headrest 10 is pivotable in the fore-aft direction to a smaller degree. FIG. 2A is a side view of the headrest assembly 10 in a substantially upright position, wherein the housing 12 is generally aligned in a substantially parallel relationship with the seatback. FIG. 2B is a side view of the headrest assembly 10 in a pivoted position, wherein the housing 12 is pivoted until it has a forward tilt with respect to the seatback, e.g., a tilt in the fore direction.

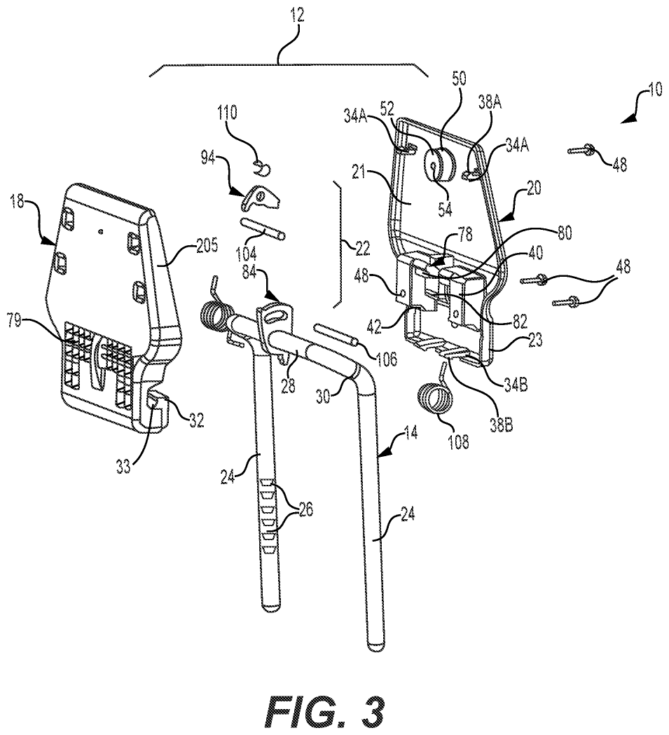

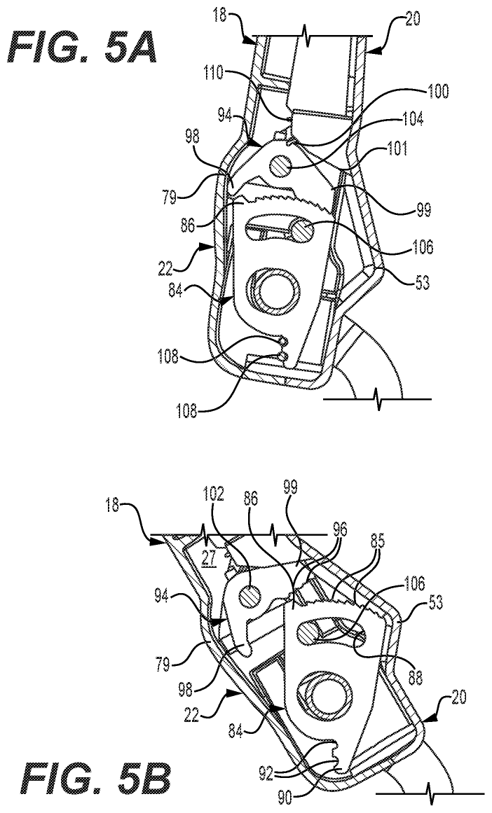

FIG. 3 is a disassembled front perspective view of the headrest assembly 10. The housing 12 includes a front shell 18 and a rear shell 20 that can be connected together to define a cavity 27 therebetween. A ratchet mechanism 22 is located within the cavity 27 (see FIGS. 5A and 5B) and controls operation of the pivoting movement.

With continued reference to FIG. 3, the armature 14 includes a pair of post members 24 that are mounted, or mountable, to the top of the seatback of the vehicle seat. Each of the post members 24 define a respective elongated, straight portion. Each of the post members 24 extend into a respective hole formed in the top of the seatback to attach the headrest assembly 10 to the vehicle seat. A series of slots 26 are located serially along at least one or both of the post members 24 for engagement with a detent (not shown) within the seatback for adjusting the headrest assembly 10 between a plurality of vertical positions. The armature 14 further includes a cross-car portion 28 that connects to each of the post members 24. More particularly, each post member 24 includes a forward oriented bend 30 that merges into the cross-car portion 28.

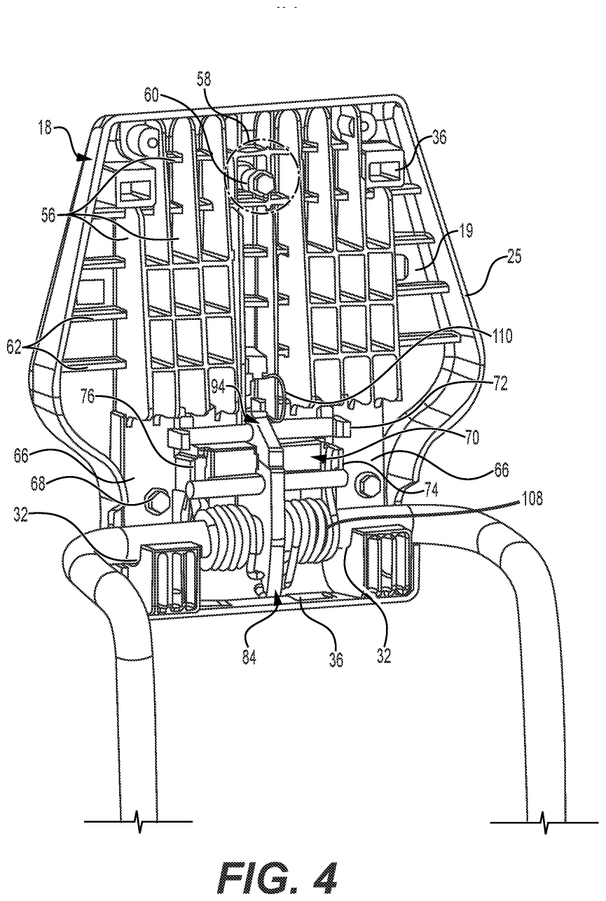

With reference to both FIGS. 3 and 4, the front shell 18 and rear shell 20 have a variety of structures that strengthen, connect, and/or assist in the pivoting movement of the headrest assembly 10. These structures may be integral with the respective shells via processes such as molding, casting, etc. The rear shell 20 includes a rear interior surface 21 (see FIG. 3) from which various supporting structures extend. Similarly, the front shell 18 has a front interior surface 19 (see FIG. 4) from which various supporting structures extend. A rear sidewall 23 extends around an edge of the rear interior surface 21 and a front sidewall 25 extends around the front interior surface 19. When the front shell 18 and rear shell 20 are connected, the respective interior surfaces 19, 21 and sidewalls 23, 25 enclose the cavity 27.

The front interior surface 19 and the front sidewall 25 of the front shell 18 define a pair of grooves 32 (see FIG. 4) spaced apart in the cross-car direction for placing the cross-car portion 28 of the armature 14 therein. A lower bearing surface 33 (FIG. 3) defines part of each groove 32 and is in relative rotational contact with the cross-car portion 28 as the headrest assembly 10 is pivoted. Once the cross-car portion 28 is located in the pair of grooves 32, the rear shell 20 can be connected to the front shell 18. More particularly, the rear shell 20 includes a plurality of connection posts 34 extending from the rear interior surface 21 and the front shell 18 includes a plurality of corresponding apertures 36 sunken into the front interior surface 19 for receiving the plurality of connection posts 34. The plurality of connection posts 34 each include a hook portion 38 such that as the connection posts 34 are drawn through a respective aperture 36 the hook portion 38 catches a portion of the front shell 18 such that it cannot be removed. For example, the front shell 18 may include a lip or projection (not shown) within each aperture to latch onto the hook portion 38. As shown in the illustrated arrangement, the rear shell 18 includes two upper connection posts 34A with upward extending hook portions 38A and two lower connection posts 34B with downward extending hook portions 38B (FIG. 3). The rear shell 20 includes a pair of projections 40 extending from the rear interior surface 21 that are located adjacent to the grooves 32 in the front portion 18 when the front shell 18 and rear shell 20 are connected. Each projection 40 includes an upper bearing surface 42 and is in relative rotational contact with the cross-car portion 28 as the headrest assembly 10 is pivoted. The lower bearing surface 33 and upper bearing surface 42 are circumferentially misaligned to define a cylindrical opening with an inner diameter equal to or slightly larger than an outer diameter of the cross-car portion 28 of the armature 14. Each of the projections 40 include a hole 46 extending entirely therethrough. A fastener 48 extends through each hole 48 and into the front shell 18 for drawing the front shell 18 and rear shell 20 together. Each of the holes 48 may be located above and adjacent to a respective upper bearing surface 42. A column 50 extends from the rear interior surface 21 to a column face 52. A column hole 54 extends through the column 50 such that another fastener 48 can be driven therethrough and into the front shell 18. The rear interior surface 21 includes a rear bulged portion 53 (FIGS. 5A and 5B) for accommodating relative movement of various features of the ratchet mechanism 22.

With specific reference to FIG. 4, an array of ribs 56 extend from the front interior surface 19. The array of ribs 56 include a series of overlapping vertical and horizontal ribs. The array of ribs 56 extend from the front interior surface 19 in a topographical configuration such that they directly interface with the rear interior surface 21 when the front shell 18 and rear shell 20 are connected. The array of ribs 56 define a depression 58 for accommodating the column 50 and directly contacting the column face 52. A fastener hole 60 is located within the depression 58 and corresponds to the column hole 54. Cross-member ribs 62 extend horizontally from the front sidewall 25 to the array of ribs 56. A pair of spaced apart flat interface surfaces 66 are located on the front interior surface 19 between the array of ribs 56 and the pair of grooves 32 for contacting the projections 40 when the front shell 18 and rear shell 20 are connected. A fastener hole 68 is located in each interface surface 66 and correspond to the holes 46 in the projections 40. The flat interface surface 66 may define a flat, non-ribbed surface.

With continued reference to FIG. 4, a front ratchet interface protrusion 70 is located between the pair of interface surfaces 66 and hold various components of the ratchet mechanism 22. More particularly, the front ratchet interface protrusion 70 includes a first pin bracket 72 and a second pin bracket 74 disposed below the first pin bracket 72. A pair of spring grooves 76 are located adjacent to the spring brackets 72, 74. As illustrated in FIG. 3, a corresponding rear ratchet interface protrusion 78 is located on the rear shell 20. The rear ratchet interface protrusion 78 includes a first pin contacting surface 80 corresponding to the first pin bracket 72 and a second pin contacting surface 82 corresponding to the second pin bracket 74. These ratchet interface protrusions 70, 78 hold components and assist in the operation of the ratchet mechanism 22. The front interior surface 19 includes a front bulged portion 79 (FIG. 5A and FIG. 5B) corresponding with the rear bulged portion 53 for accommodating relative movement of various features of the ratchet mechanism 22.

The ratchet mechanism 22 is illustrated in FIGS. 3 through 5B and couples the housing 12 to the armature 14. The ratchet mechanism 22 includes a fixed ratchet member 84 statically connected to the armature 14. More particularly, the fixed ratchet member 84 includes a ratchet surface defining a plurality of fixed ratchet teeth 85 and an actuation projection 86. The fixed ratchet member 84 further includes an elongated opening 88 and a tail 90 with a pair of grooves 92. The ratchet mechanism 22 further includes a moveable ratchet member 94 pivotally connected to the housing 12 that includes a ratchet surface defining a plurality of moveable ratchet teeth 96. The moveable ratchet member 94 further includes a pivot arm 98 and a spring notch 100 located between the pivot arm 98 and the moveable ratchet teeth 96. The moveable ratchet member 94 includes a pivot pin opening 102.

As best illustrated in FIG. 4, the ratchet mechanism 22 includes a first pivot pin 104 and a second pivot pin 106. The first pivot pin 104 is located in the first pin bracket 72 in the first shell 18 and is in contact with the first pin contacting surface 80 on the rear shell 20. The first pivot pin 104 extends through the pivot pin opening 102 of the moveable ratchet member 94. The moveable ratchet member 94 may pivot relative to the first pivot pin 104 and/or the first pivot pin 104 may rotate within the first pin bracket 72 relative to the housing 12. The second pivot pin 106 is located in the second pin bracket 74 in the first shell 18 and is in contact with the second pin contacting surface 82 on the rear shell 20. The second pivot pin 106 extends through the elongated opening 88 of the fixed ratchet member 84. At least one spring 108 biases the second pivot pin 106 in the fore direction with respect to the elongated opening 88. The at least one spring 108 may include a pair or torsion springs 108 located on either side of the fixed ratchet member 84. Each torsion spring 108 includes an extended portion that fits within one of the grooves 92 on the tail 90 of the fixed ratchet member 84 and an extended portion on the opposite end that presses against the first pivot pin 104. An upper spring 110 includes a first end located in the notch 100 of the moveable ratchet member 94 and second end connected to front shell 18. The upper spring 110 may also be configured as a torsion spring 110 or a horse-shoe shaped spring.

In operation, the ratchet mechanism 22 includes an engaged position (FIG. 5A), wherein the fixed ratchet teeth 84 and the moveable ratchet teeth 96 are interlocked and a released position (FIG. 5B) wherein the fixed ratchet teeth 84 and the moveable ratchet teeth 96 are spaced apart. In the engaged position, pivoting of the housing 12 in the fore-aft direction causes ratcheting between respective teeth 84, 96 to lock the housing 12 at varying pivot (tilt) angles in the fore-aft direction with respect to the seatback. In one arrangement, the teeth 84, 96 are arranged such that the housing 12 adjusts 4.7 degrees per ratcheted tooth and includes approximately 28 degrees of total pivot angles. As the housing 12 is pivoted, the fixed ratchet member 84 can travel within the rear bulged portion 53 relative to the rear shell 20 and the moveable ratchet member 94 can travel within the front bulged portion 79 relative to the front shell 18. Once the housing 12 has been pivoted enough, the actuation projection 86 contacts the ratchet surface of the moveable ratchet member 94 and lifts the moveable ratchet teeth 96 away from the fixed ratchet teeth 84 such that the ratchet mechanism 22 is in the released position. Once the ratchet mechanism 22 is in the released position, the housing 12 can be pivoted back in the opposite direction, wherein the pivot arm 98 of the moveable ratchet member 94 catches the actuation projection 86 and cause the teeth 84, 96 to be re-engaged as the ratchet mechanism 22 is moved back to the engaged position. In the illustrated arrangement, the engaged position prevents the headrest assembly 10 from pivoting in the aft direction but allows it to pivot in the fore direction to a preferred position until it is pivoted enough that it is released by the actuation projection 96. Once in the released position, the headrest assembly 10 can be pivoted back in the aft direction to reset the headrest assembly 10 position to a starting location. In the starting location, the housing 12 may be generally parallel with the seatback, it may have a forward tilt, or a rearward tilt depending on application and preference. The moveable ratchet member 94 may further define an abutment surface 99 located opposite the moveable ratchet teeth 96 and the rear interior surface 21 of the rear shell 20 may further include an opposing abutment surface 101 for contacting the abutment surface 99 and limiting the pivoting movement of the moveable ratchet member 94.

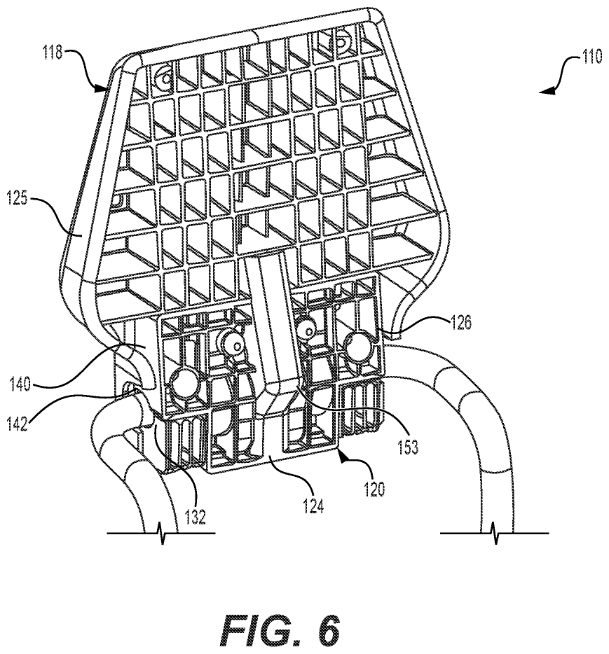

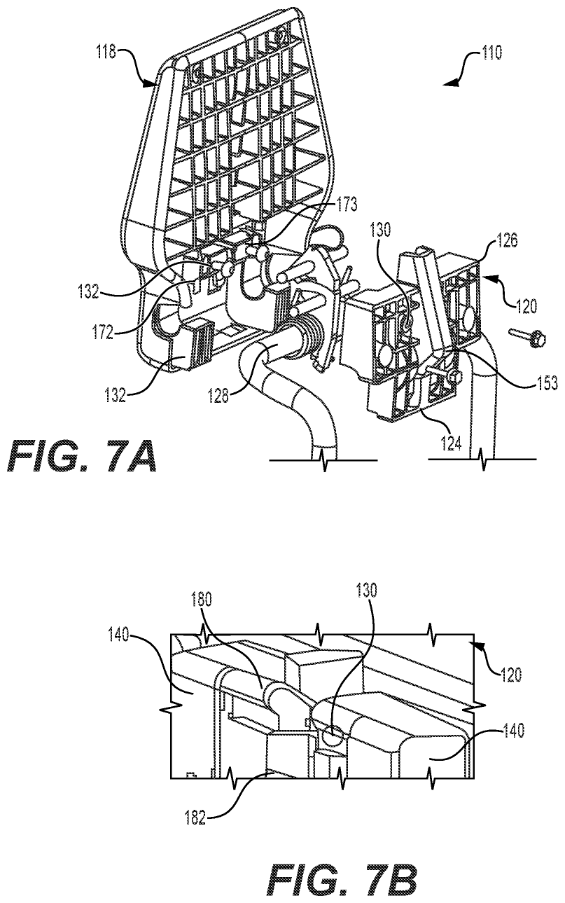

FIGS. 6 through 7B illustrate the headrest assembly 110 in accordance with another embodiment. The headrest assembly 110 includes an arrangement that is similar to the headrest assembly illustrated in FIGS. 1 through 5B. More particularly, the headrest assembly 110 includes a ratchet mechanism 122 and a front shell 118 with minor differences compared to headrest assembly 10. A rear shell 120, however, fits primarily within a sidewall 125 of the front shell 118 and is large enough to cover the entire ratchet mechanism 122. The rear shell 120 includes the components of the rear ratchet interface protrusion 78 described in FIG. 3. As best illustrated in FIG. 6, the rear shell 120 includes a lower portion 124 that is located between a pair of grooves 132 on the front shell 118. The rear shell 120 further includes a wider portion 126 above the lower portion 124 that widens in the cross-car direction. A pair of projections 140 are located on the wider portion 126 in a similar orientation to those (projections 40) presented in FIG. 3. Each projection 140 includes an upper bearing surface 142 that is in relative rotational contact with the cross-car portion 128 as the headrest assembly 110 is pivoted. A first pin contacting surface 180 and a second pin contacting surface 182 are located between the projections 140 (see FIG. 7B). The rear shell 120 further includes a rear bulged portion 153 near the pin contacting surfaces for accommodating relative movement of various features of the ratchet mechanism 122. A through hole 130 extends between the first pin contacting surface 180 and the second pin contacting surface 182. As best illustrated in the disassembled view in FIG. 7A, the front shell 118 incudes corresponding front through holes 132 located on a front shell protrusion 173. The front shell protrusion 173 is located within a first pin bracket 172. Once assembled, a cushion and a cover (not shown) may be provided.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A headrest assembly for use in a vehicle comprising:
a housing; and
a ratchet mechanism coupling the housing to a provided armature, the ratchet mechanism comprising:
a fixed ratchet member for static connection to the provided armature and defining a plurality of fixed ratchet teeth;
a moveable ratchet member pivotally connected to the housing and defining a plurality of moveable ratchet teeth; and
the moveable ratchet member moveable between an engaged position and a released position, the engaged position at least partially defined by the fixed ratchet teeth and the moveable ratchet teeth interlocked at varying pivot angles in the fore-aft direction with respect to the provided armature, the unengaged position at least partially defined by the fixed ratchet teeth and the moveable ratchet teeth being spaced from one another.

2. The headrest assembly of claim 1, wherein the moveable ratchet member is biased in the engaged position by at least one spring.

3. The headrest assembly of claim 1, wherein the engaged position is further defined by the fixed ratchet teeth and the moveable ratchet teeth interlocked and configured to be moveable in only one of the fore-aft direction with respect to the provided armature.

4. The headrest assembly of claim 3, wherein the engaged position is further defined by the fixed ratchet teeth and the moveable ratchet teeth interlocked and configured to be moveable in only the fore direction with respect to the provided armature.

5. The headrest assembly of claim 3, wherein the fixed ratchet member includes an actuation projection that rotates the moveable ratchet member from the engaged position to the released position after the pivot angle reaches a first predetermined degree.

6. The headrest assembly of claim 5, wherein the moveable ratchet member includes a pivot arm that engages the fixed ratchet member in the released position and rotates the moveable ratchet member into the engaged position after the pivot angle reaches a second predetermined degree.

7. The headrest assembly of claim 6, wherein the fixed ratchet member includes an elongated opening and a first pivot pin connects the moveable ratchet member to the housing and a second pivot pin extends through the elongated opening and connects to the housing, wherein the second pivot pin travels in the elongated opening between the varying pivot angles.

8. The headrest assembly of claim 7, wherein at least one spring biases the second pivot pin in the fore direction with respect to the elongated opening.

9. The headrest assembly of claim 8, wherein the fixed ratchet member includes a tail and the at least one spring includes a torsion spring extending between the tail and the second pivot pin.

10. The headrest assembly of claim 1, wherein the housing includes a rear bulged portion for providing space to accommodate relative movement of at least one of the moveable ratchet member or the fixed ratchet member.

11. The headrest assembly of claim 10, wherein the housing includes a front budged portion aligned with the rear bulged portion for providing additional space to accommodate relative movement of at least one of the moveable ratchet member or the fixed ratchet member.

12. The headrest assembly of claim 1, wherein the housing includes a front shell and a rear shell connected to one another to form a cavity wherein the ratchet mechanism is located.

13. The headrest assembly of claim 12, wherein the front shell includes a front inner surface defining a pair of grooves located on either side of the ratchet mechanism in a cross-car direction, wherein each of the grooves includes a first bearing surface for rotational contact with the provided armature.

14. The headrest assembly of claim 13, wherein the rear shell includes a rear inner surface defining a pair of projections located on either side of the ratchet mechanism in the cross-car direction, wherein each of the projections includes a second bearing surface for rotational contact with the provided armature.

15. The headrest assembly of claim 14, wherein the first bearing surfaces and the second bearing surfaces are circumferentially misaligned with respect to the provided armature.

16. A headrest assembly for use in a vehicle comprising:
a housing;
an armature for operatively coupling the housing to a provided seatback of an automobile seat; and
a ratchet mechanism coupling the housing to the armature, the ratchet mechanism comprising:
a fixed ratchet member statically connected to the armature and defining a plurality of fixed ratchet teeth;
a moveable ratchet member connected to the housing and defining a plurality of moveable ratchet teeth; and
the moveable ratchet member moveable between an engaged position and a released position, the engaged position at least partially defined by the fixed ratchet teeth and the moveable ratchet teeth interlocked at varying pivot angles in the fore-aft direction with respect to the armature, the unengaged position at least partially defined by the fixed ratchet teeth and the moveable ratchet teeth being spaced from one another.

17. The headrest assembly of claim 16, wherein the armature includes a pair of post members operatively coupled to the provided seatback of an automobile seat, each post member extending to a forward oriented bend that merges into a cross-car portion, and wherein the housing is connected to the cross-car portion.

18. The headrest assembly of claim 17, wherein the housing includes a front shell and a rear shell connected to one another to form a cavity wherein the ratchet mechanism is located.

19. The headrest assembly of claim 18, wherein the front shell includes a front inner surface defining a pair of grooves located on either side of the ratchet mechanism in the cross-car direction, wherein each of the grooves includes a first bearing surface for rotational contact with the cross-car portion of the armature, and wherein the rear shell includes a rear inner surface defining a pair of projections located on either side of the ratchet mechanism in the cross-car direction, wherein each of the projections includes a second bearing surface for rotational contact with the cross-car portion of the armature opposite the first bearing surfaces.

20. The headrest assembly of claim 19, wherein the front shell includes a sidewall extending around the front inner surface and wherein the rear shell fits primarily within the sidewall.
